(19) United States
(12) Patent Application Publication
(10) Pub. No.: US 2009/0228834 A1
(43) Pub. Date: Sep. 10, 2009

(54) FLOW RADIOLOGY USER INTERFACE

(76) Inventor: Christopher REYNOLDS, Phoenix, AZ (US)

Correspondence Address: HOLME ROBERTS & OWEN LLP, 16427 N. SCOTTSDALE RD., SUITE 300, SCOTTSDALE, AZ, 85254, US

(21) Appl. No.: 12/396,408

(22) Filed: Mar. 2, 2009

Related U.S. Application Data
(60) Provisional application No. 61/032,434, filed on Feb. 29, 2008.

(51) Int. Cl. G06F 3/048

(52) U.S. Cl. 715/825; 715/830

(57) ABSTRACT

The present invention concerns a novel and non-obvious system for viewing and interpreting radiology films by integrating one or more prior films from the same subject with the current film in a manner that produces a chronological moving image of the films.

### CLAIM TO DOMESTIC PRIORITY

The present application claims the benefit of U.S. Provisional Patent Application No. 61/032,434 filed on Feb. 29, 2008, entitled “Flow Radiology User Interface,” the entire disclosure of which is incorporated herein by reference in its entirety for all purposes.

### FIELD OF THE INVENTION

This invention relates generally to the field of radiology, and more specifically to a system for viewing and interpreting radiology films by integrating one or more prior films and their corresponding reports from the same subject with the current film in a manner that produces a chronological moving image of the films.

### BACKGROUND OF THE INVENTION

Radiology is the medical specialty directing medical imaging technologies to diagnose and sometimes treat diseases. Originally it was the aspect of medical science dealing with the medical use of electromagnetic energy emitted by x-ray machines or other such radiation devices for the purpose of obtaining visual information as part of medical imaging. Radiology that involves use of x-ray is called roentgenology. Today, following extensive training, radiologists direct an array of imaging technologies (such as ultrasound, computed tomography (CT) and magnetic resonance imaging) to diagnose or treat disease. The acquisition of medical imaging is usually carried out by the radiographer or radiology technologist. Outside of the medical field, radiology also encompasses the examination of the inner structure of objects using x-rays or other penetrating radiation.

Diagnostic radiologists must complete prerequisite undergraduate training, four years of medical school, and five years of post-graduate training. The first postgraduate year is usually a transitional year of various rotations but is sometimes a preliminary internship in medicine or surgery. A four-year diagnostic radiology residency follows. During this residency, the radiology resident must pass a medical physics board exam covering the science and technology of ultrasounds, CTs, x-rays, nuclear medicine, and MRI. After successful completion of the physics examination, the resident is eligible to take the written, and, if passed, the oral board examinations given by the American Board of Radiology.

Following completion of residency training, radiologists either begin their practice or enter into sub-specialty training programs known as fellowships. Examples of sub-specialty training in radiology include abdominal imaging, thoracic imaging, CT/ultrasound, MRI, musculoskeletal imaging, interventional radiology, neuroradiology, interventional neuroradiology, pediatric radiology, and women's imaging. Fellowship training programs in radiology are usually one or two years in length.

Once training is concluded, a radiologist is expected to access a radiology study or film (hereinafter referred to as a current study or CST), interpret the CST in the most accurate manner possible using the appropriate number of past studies (hereinafter known as PSTs) and/or past reports (hereinafter known as PRPs) for comparison and generate a report on the current study (also referred to as a CRP) while maintaining the highest level of efficiency.

In general, reviewing more PSTs and their corresponding PRPs increases diagnostic accuracy in interpreting the CST and generating the CRP. However, reviewing more PSTs and PRPs also results in a corresponding decrease in the efficiency of interpreting the CST and generating the CRP.

### BRIEF DESCRIPTION OF THE DRAWINGS

FIG. 1A is an example of a typical PACS system with the CST and 2 PSTs for comparison

FIG. 1B shows a typical PACS system where 6 PSTs were available for comparison.

FIG. 2 is an example of an integrated RIS/PACS system with CRP available in the RIS on the left along with a list of PSTs available for comparison.

FIG. 3 is an example of workflow in an existing integrated Radiology Information System/Picture Archiving and Communication System/Voice Recognition (RIS/PACS/VR) system. Specifically, FIG. 3A is CST on right compared to PST in middle; FIG. 3B illustrates additional PSTs reviewed to attempt to improve diagnostic accuracy; and FIG. 3C illustrates how this continues for each PST.

FIG. 4 illustrates one embodiment of the present invention as described in further detail below.

### DETAILED DESCRIPTION OF VARIOUS EMBODIMENTS

Thus, the present disclosure provides for a novel and non-obvious system for viewing and interpreting radiology films by integrating one or more PSTs and their corresponding PRPs from the same subject with the CST in a manner that produces a chronological moving image of the STs and RPs. This system will allow for seamless integration of any number of PSTs and PRPs for comparison to maximize accuracy in interpreting the CST while minimizing the decrease in efficiency that such a comparison usually engenders.

As used in this present disclosure, the following abbreviations have the following meanings:

ST or STs mean STudy or STudies

RP or RPs mean RePort or RePorts

C means Current

CST means Current STudy

CRP means Current RePort

P means Prior

PST means Prior STudy

PRP means Prior RePort

PACS means Picture Archiving and Communication System

DICOM means Digital Imaging and Communications in Medicine

RIS means Radiology Information System

VR means Voice Recognition

UI means User Interface

As disclosed herein, radiologic STs are comprised of a series of images from a given modality, e.g. x-ray (also referred to as XR), ultrasound (US), computed tomography scan (CT), positron emission technology scan (PET) and magnetic resonance imaging (MRI). In a filmless setting, STs are managed using a PACS. Images from a ST are stored in a format independent of the PACS, most commonly in DICOM format. A RIS is used to store, manipulate and distribute patient radiological data. The RIS is generally used for patient tracking and scheduling and viewing and tracking RPs. RPs are documents generated by a radiologist that contain all of the important information about a ST, including information such as patient demographic data, date and time the ST was performed, technique used, findings, impressions and diagnosis of disease or other condition.

Currently, the RIS and PACS may or may not be integrated into a single interface depending on the system(s) used and their configuration. If a department has RIS/PACS integration, PRPs and PSTs can be viewed for comparison to a CST via a single interface. Additionally, the integration of VR would allow the radiologist to view the CRP as it is being generated while viewing the CST, PSTs and PRPs.

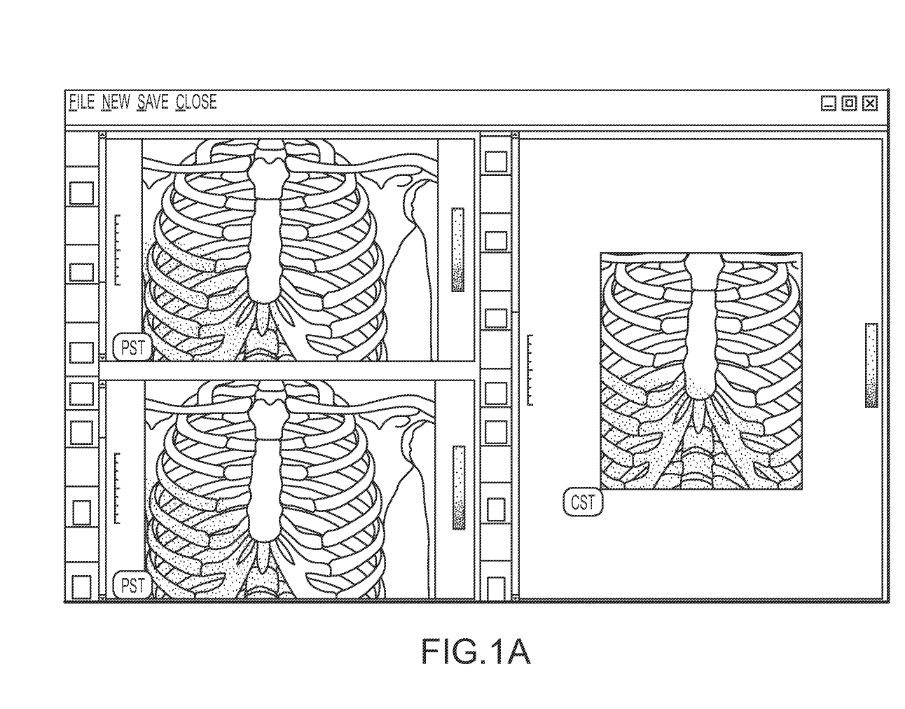

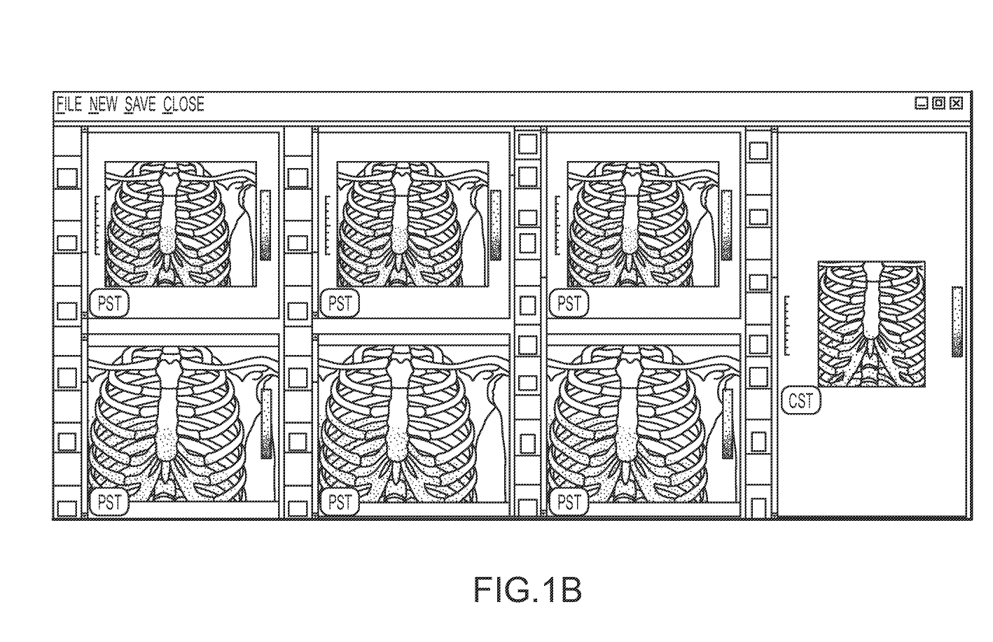

FIG. 1A is an example of a typical PACS system with the CST and two PSTs for comparison and the limitations of side-to-side comparison with a large number of PSTs. The RIS is not integrated so CRP and PRPs are not available. Additionally, STs must be compared side-to-side. As shown in FIG. 1A, the radiology information system (RIS) with VR integration is on the left. The CST is displayed in the center, and the PST is on the right. The CST and PST position is user defined. The overlay window in the center is the list showing PSTs available for comparison and is sortable by criteria such as date ST performed, ST modality, ST status, or accession number along with a thumbnail of the images. The PST or PSTs are opened for comparison to the CST via this list. However, the corresponding PRPs, which are not visible, must be accessed separately and independently via the RIS. Additionally, PRP may or may not be viewable at the same time as the CRP being generated via VR.

FIG. 1B shows a typical PACS system where six PSTs were available for comparison; however, it is difficult to view all of the PSTs at one time. Diagnostic accuracy decreases as the size of the tiles decreases to accommodate more images.

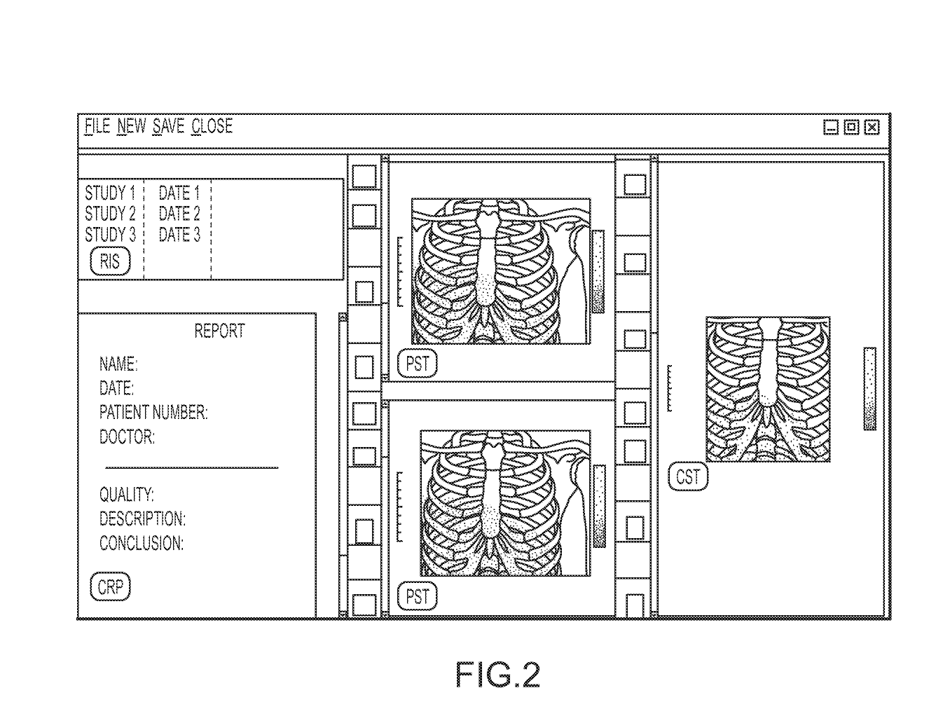

FIG. 2 is an example of an integrated RIS/PACS system with CRP available in the RIS on the left along with a list of PSTs available for comparison. FIG. 2 illustrates the fundamental limitations of current integrated RIS/PACS system. The PRPs for the PSTs in the list cannot be viewed while the CRP is being generated. If they are accessed, they can only be viewed one at a time and must be accessed independent of the PST being viewed. There is no integration of the PSTs being viewed in the PACS on the right and their corresponding PRPs in the RIS.

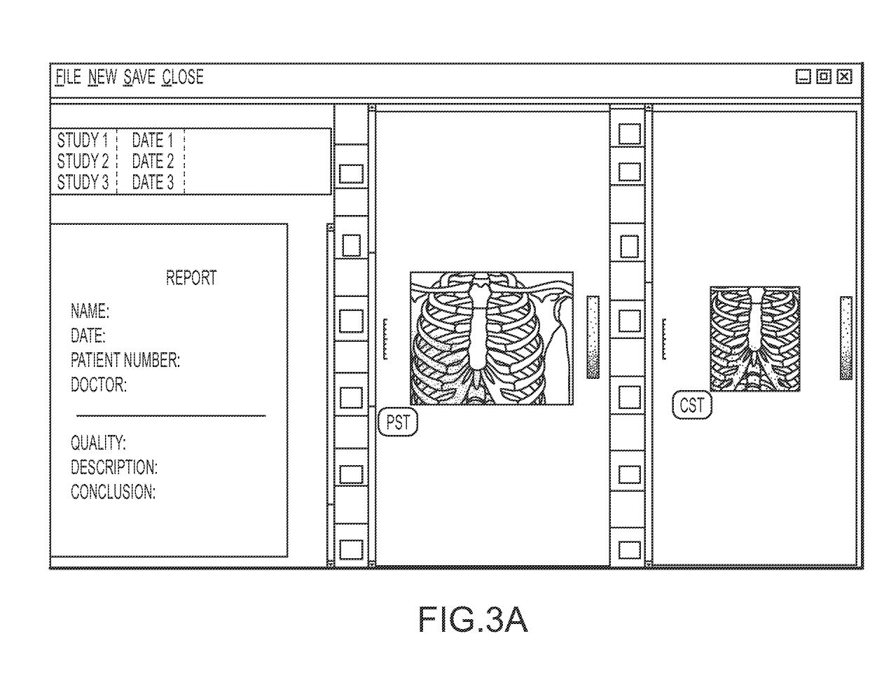

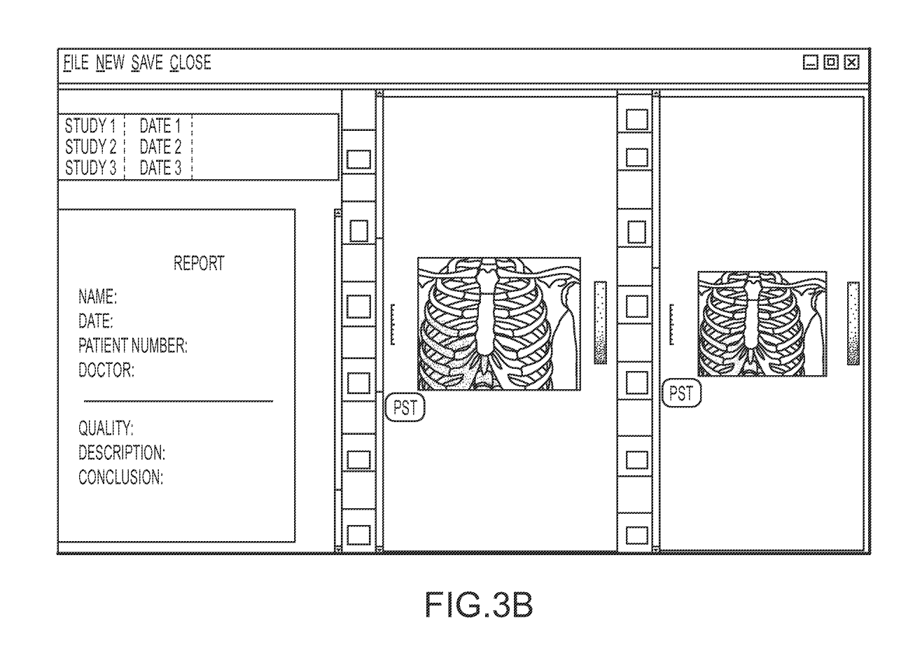

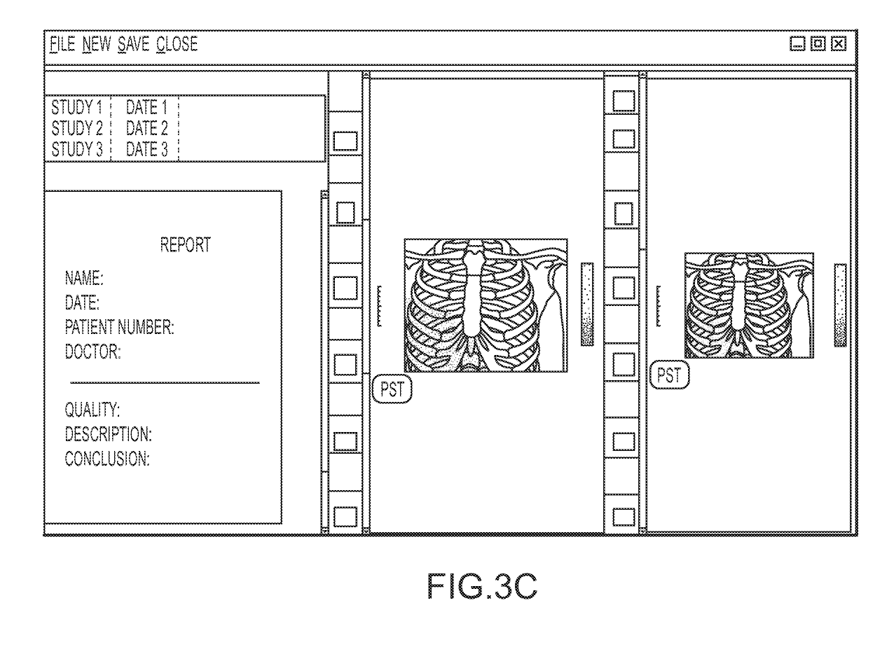

FIG. 3 illustrates an example of workflow in a current integrated RIS/PACS/VR system and the limitations of the commonly used method of comparison: side-to-side and one at a time. Integrated PACS and RIS provide access to the PSTs and PRPs respectively in one place. PST's can be accessed from the PST list in a moveable window that sits on top of the interface. PRPs can be accessed from a list in the RIS on the far left screen. Ease of access increases the likelihood that the interpreting radiologist will look at the PSTs and/or the PRPs, which will result in more accurate interpretation of the CST. Furthermore, integration of VR provides visualization of the CRP as it is being generated and avoids the time delay of having to go back and review the CRP for mistakes after it is transcribed. The report is transcribed and finalized at the time of interpretation.

If the RIS and PACS were not integrated, the PSTs might still be accessible through the PACs, but the PRPs would be accessed separately (e.g. on a separate computer or separate monitor running the RIS), resulting in the following problems: (1) increased time to access PRPs; (2) increased time to correlate PSTs with PRPs; (3) increased time to generate CRP; (4) decreased likelihood that the interpreting radiologist would go to the trouble of comparing the CST to the PSTs and/or PRPs; and (5) decreased accuracy in interpreting the CST.

However, even with integrated systems, there are numerous problems and disadvantages. Specifically, FIG. 3A illustrates a CST on right compared to PST in middle. Here, the radiologist must look side-to-side to detect subtle changes. FIG. 3B further illustrates additional PSTs reviewed to attempt to improve diagnostic accuracy. Here, the radiologist must again look at this PST to detect subtle changes while trying to remember what the changes from the other PST were. FIG. 3C illustrates how this continues for each PST. Additionally, the PRPs that correspond to the PST are not integrated. If the radiologist wanted to view them for a complete comparison, they would have to be accessed independently and one at a time through the RIS.

Thus, even in the most sophisticated existing systems, the PST and PRP are not integrated or linked together, making it difficult to view them together while the CST is being interpreted and the CRP is being generated. The two parts of a full comparison, namely the PST and the PRP, remain independent of one another even if they can both be accessed via an integrated RIS/PACS.

Further, as shown in FIG. 3, each time a different PST is accessed on the right monitor, the PRP on the left monitor stays the same and does not change to match the PRP being viewed. Therefore, a complete comparison requires an arduous and inefficient two-step process: (1) opening the PST in the PACS system and (2) opening the PRP in the RIS. Additionally, while the PRP is being viewed in the RIS on the left monitor, the CRP usually cannot be viewed. Therefore, the interpreting radiologist would not be able to view the PRP in conjunction with the PST while evaluating the CST and generating the CRP. Rather, the PRP would have to be closed.

Also, in many systems, the PSTs and PRPs must be viewed one at a time. Thus, in order to perform a first comparison, the interpreting radiologist pulls up the PST in the PACS (FIG. 3A), then pulls up the corresponding PRP separately in the RIS (FIG. 3B). Then, in order to perform a second comparison, the interpreting radiologist pulls up this PST in the PACS, then pulls up the corresponding PRP separately in the RIS (FIG. 3C). However, once this is done, the first PST and PRP (FIG. 3B) from are no longer visible, i.e. the CST (FIG. 3A) can only be compared to the PST and PRP from FIG. 3C. Even in some systems that allow for comparison to multiple PSTs, they must all be opened as tiles in the same window, often making them too small for accurate interpretation, as illustrated in FIG. 1B. Additionally, each PRP would still have to be pulled up separately, and they could only be viewed one at a time.

The following three examples illustrate daily situations that a radiologist encounters that highlight the need for rapid and easy comparison of multiple STs and RPs. An ICU patient with daily chest films taken over a period of the past month produces a total of more than 30 films that must be reviewed to determine if a pulmonary infiltrate on the CST represents pneumonia, that may require antibiotics, or atelectasis, that requires no medication.

A patient coming in for screening mammography has a suspicious nodule on the CST. This patient might have up to twenty or more PST mammograms that must now be reviewed to determine if this nodule has changed, suggesting cancer that would necessitate a biopsy and possible surgery, or if this nodule had not changed, had just gone unnoticed on the PSTs and, therefore, required no treatment. Finally, a patient who has undergone hip replacement comes to the orthopedic clinic every two weeks for follow up and develops pain after six months that is concern for infection of the hardware, requiring review of twelve PSTs and PRPs to detect subtle changes that may suggest osteomyelitis, which may require surgery to remove and/or replace the prosthesis. These are common examples where viewing CSTs in light of many PSTs is imperative but could take hours, costing valuable time and increasing health care costs.

Another disadvantage of the current systems is that CSTs and PSTs must be compared side by side. Even if the PSTs are pulled up one at a time and the radiologist is able to go through each one sequentially and separately review each corresponding PRP, it is still extremely difficult to detect subtle changes by comparing the two STs side by side. In doing this side-by-side comparison, the radiologist is essentially attempting to perform the following five-step mental process without any technical assistance from the system: (1) look side to side (STS) between the CST and the first PST; (2) mentally merge, or superimpose, the CST and the first PST to try to detect any changes; (3) try to remember what those changes were when the first PST is closed and a second PST is pulled up to compare STS with the CST; (4) mentally merge, or superimpose, the CST and second PST to try to detect any changes while trying to remember what the first PST looked like and what changes were present between the first PST and the CST; and (5) perform steps 1-4 all while independently and separately pulling up the PRPs to see what findings were mentioned on each PST.

Unfortunately then, due to lack of efficient access to PSTs and PRPs, an interpreting radiologist will often choose some variation of three existing options: (1) not review any PSTs or PRPs in an attempt to be as efficient as possible with a corresponding detriment to accurate interpretation of the CST, (2) only review select PSTs or PRPs as deemed necessary for timely interpretation of the CST (e.g. the most recent PST or the PST from one year ago to confirm chronicity of a finding) in an attempt to slightly improve accuracy; or (3) review as many PSTs or PRPs as possible in an attempt to maximize accuracy with a corresponding, and unacceptable, decrease in efficiency.

Thus, the purpose of this disclosure is to define a new user interface that notifies the radiologist reading a CST how many, if any, PSTs are available for comparison, allows the radiologist to select any number of those PSTs to be used for comparison, integrates the selected PSTs with the corresponding PRPS, and display the PSTs and PRPs side by side in a novel way that merges the PSTs into a sequential movie with the CST as the end point in the comparison. Additionally, this novel comparison user interface can be utilized to review the other STs that a patient has had, regardless of modality, in order to get a comprehensive overview of the patient's current condition. For example, the user could open one window of the interface to compare the CST chest radiograph to all of the PST chest radiographs available while opening a separate window to quickly review all of the PST abdominal radiographs and RPs to look for any related pathology in the abdomen.

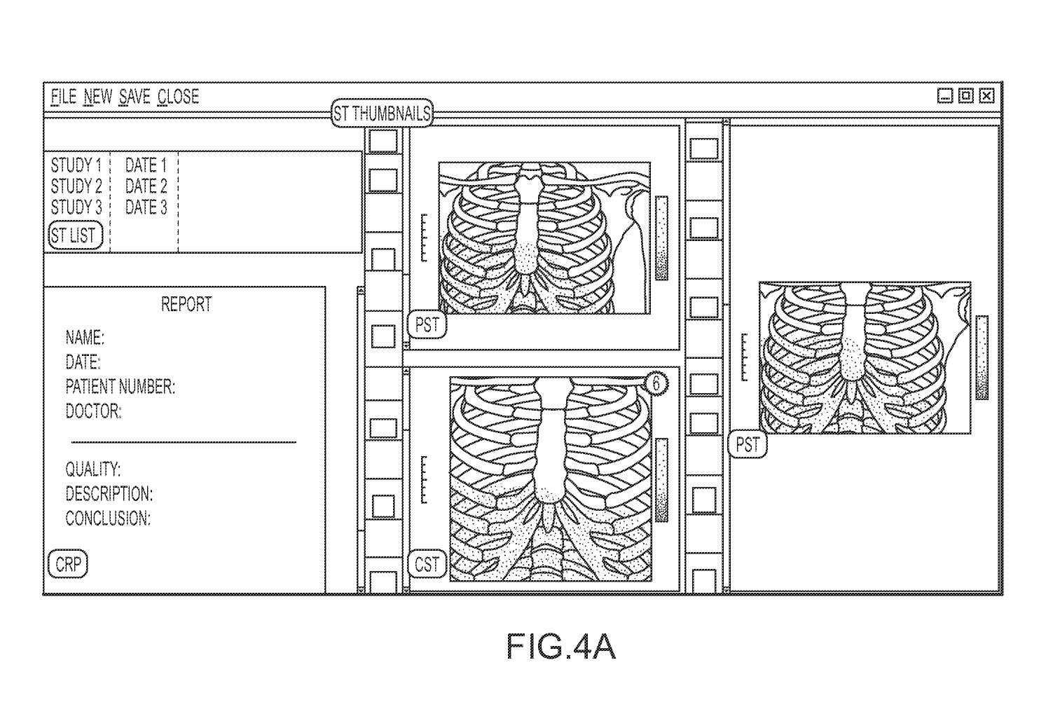

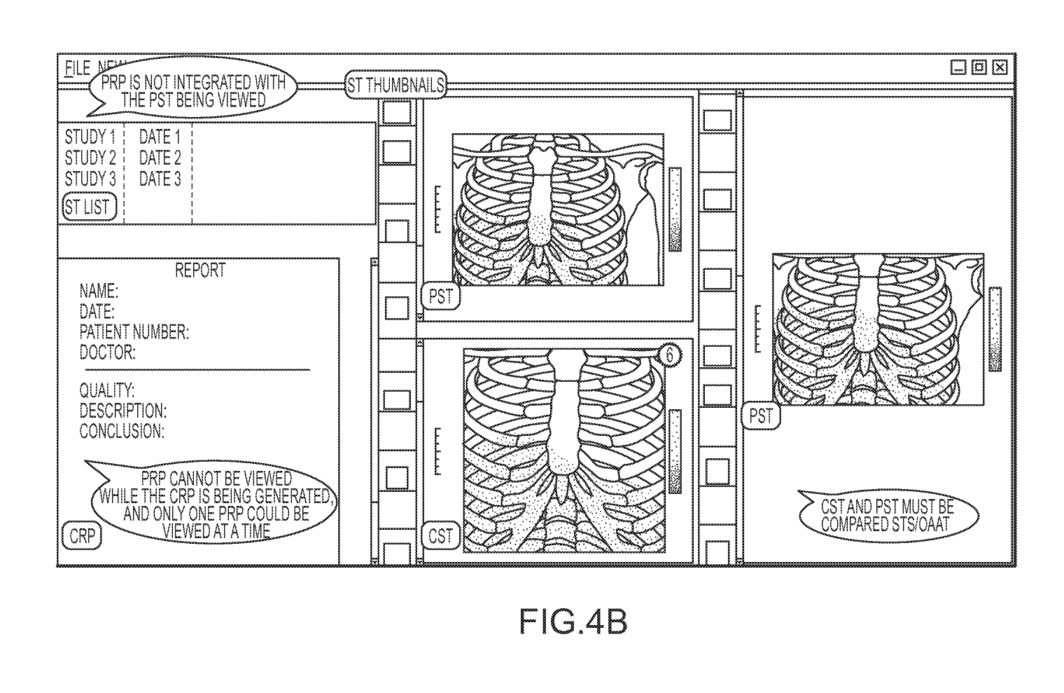

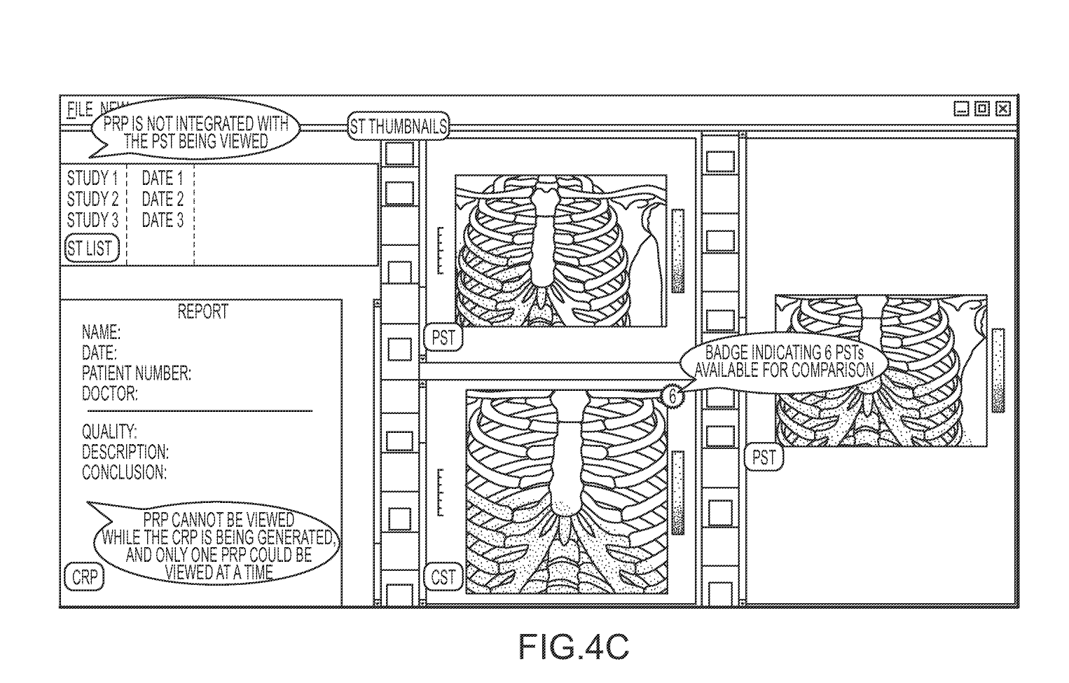

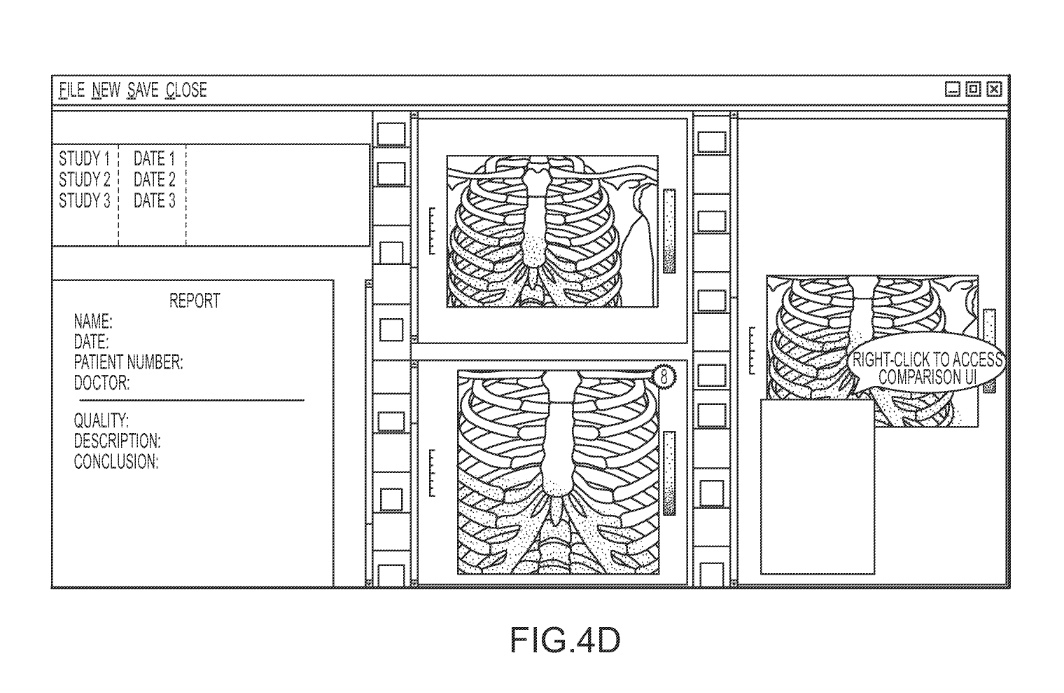

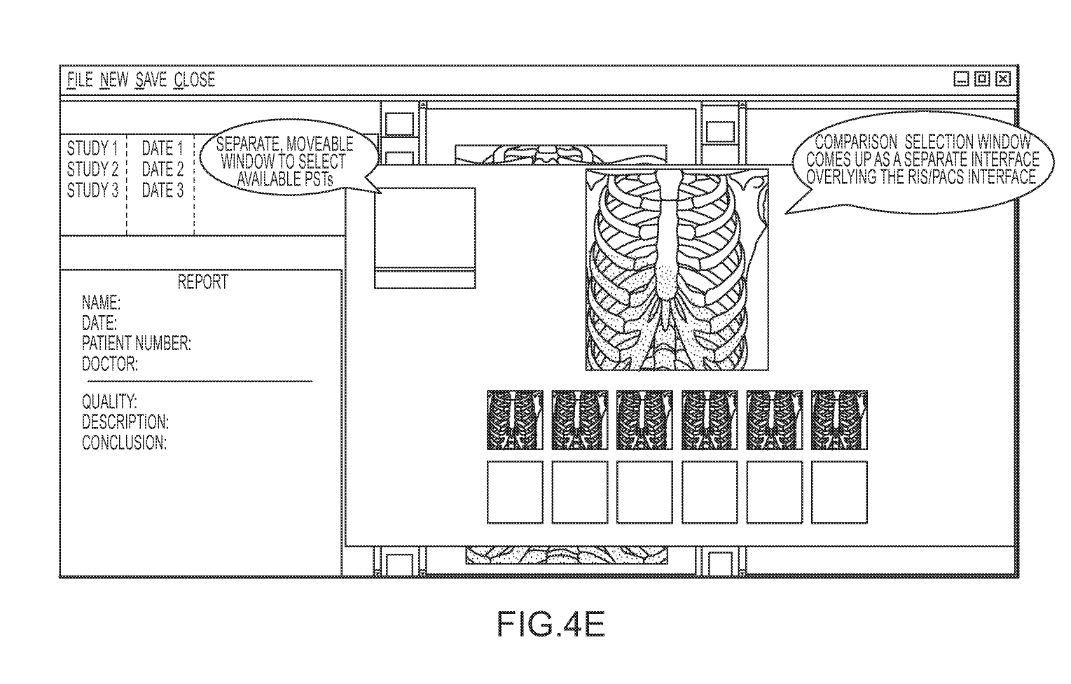

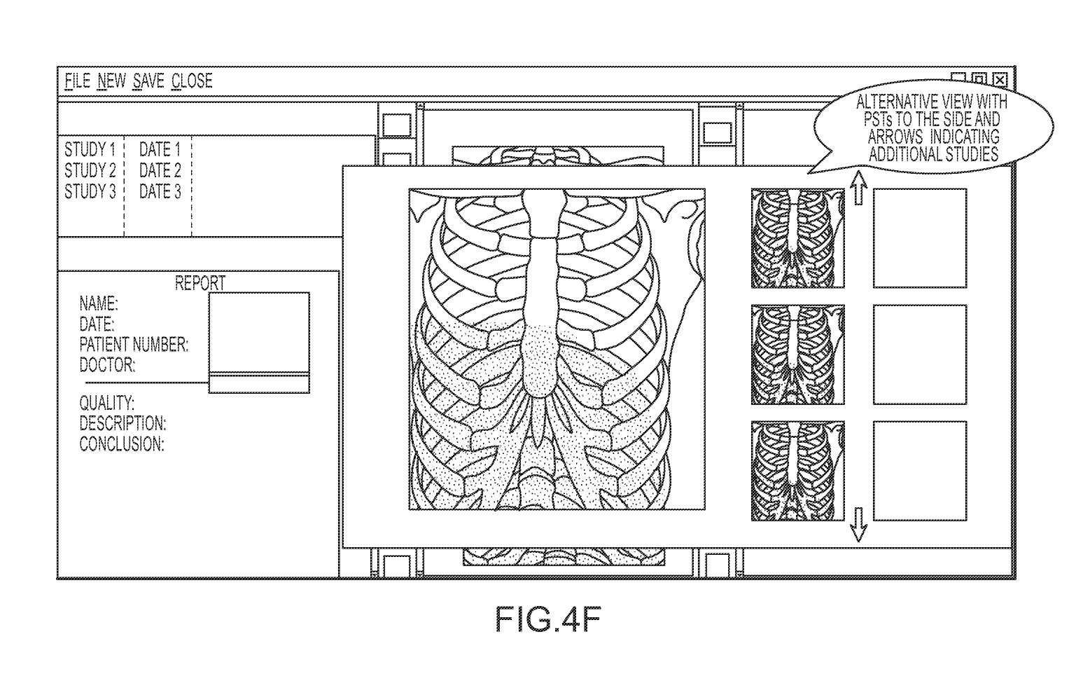

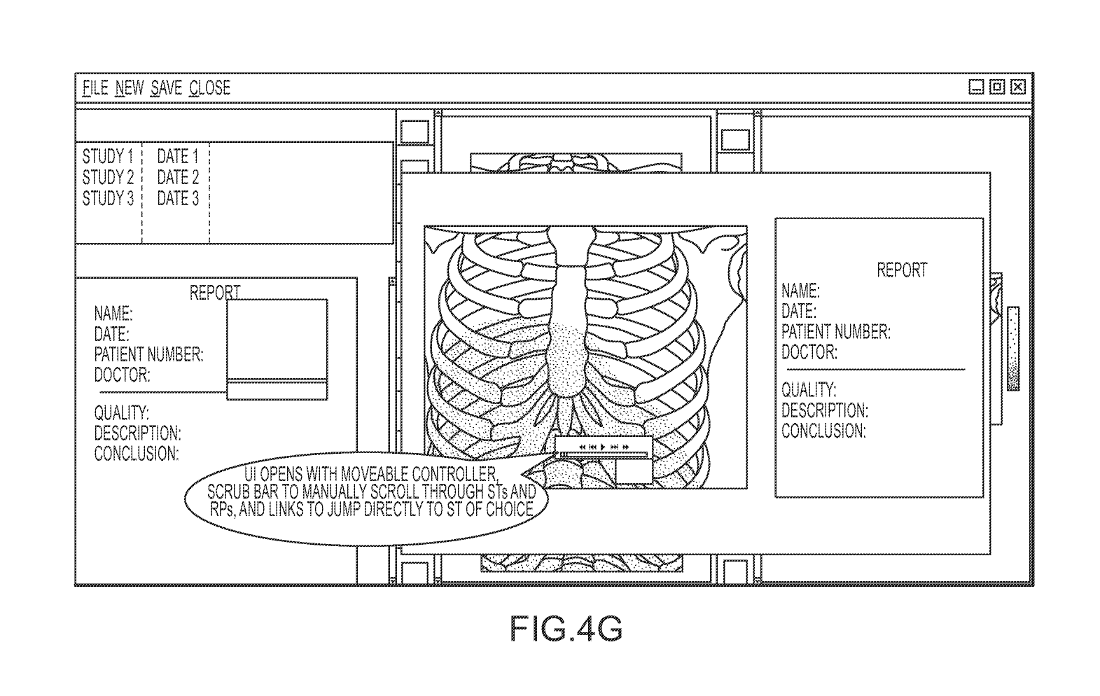

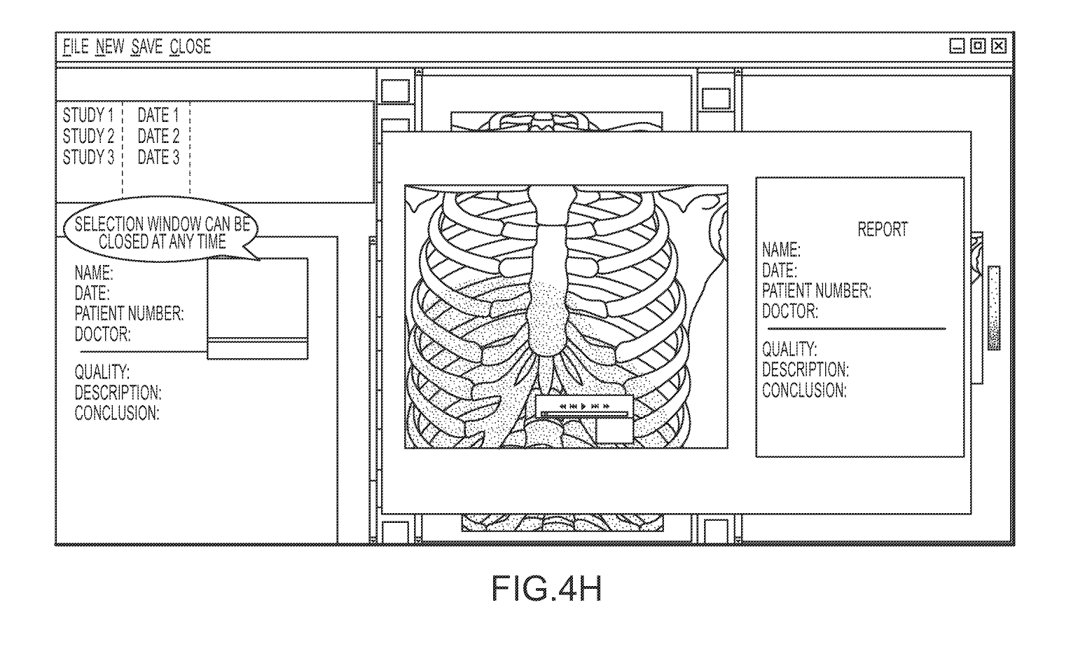

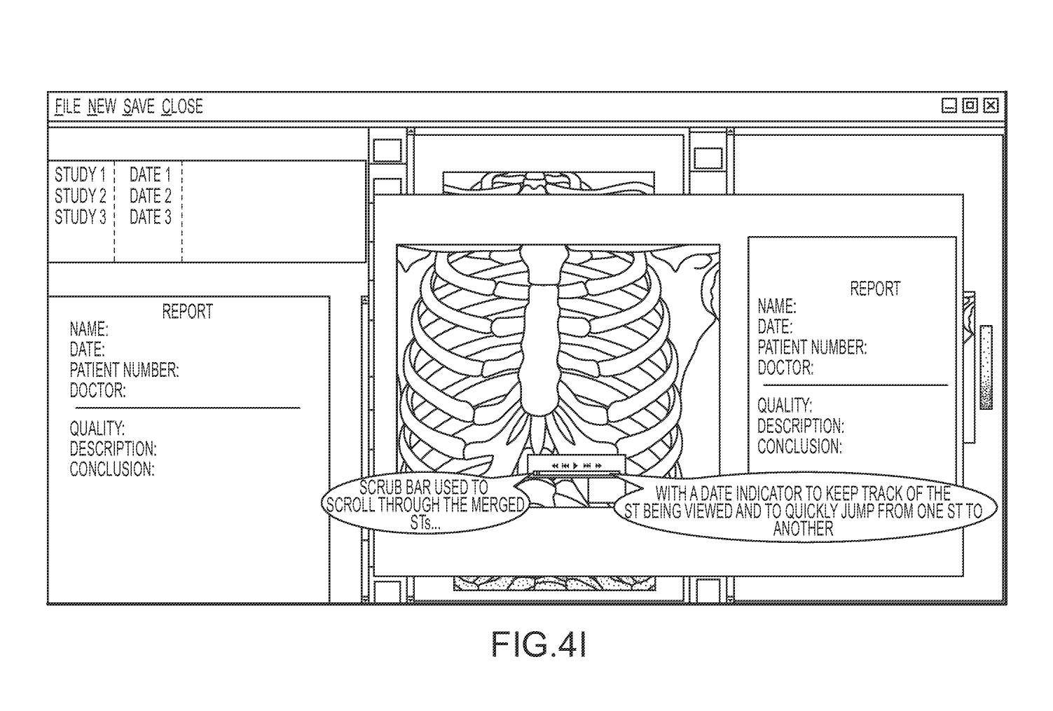

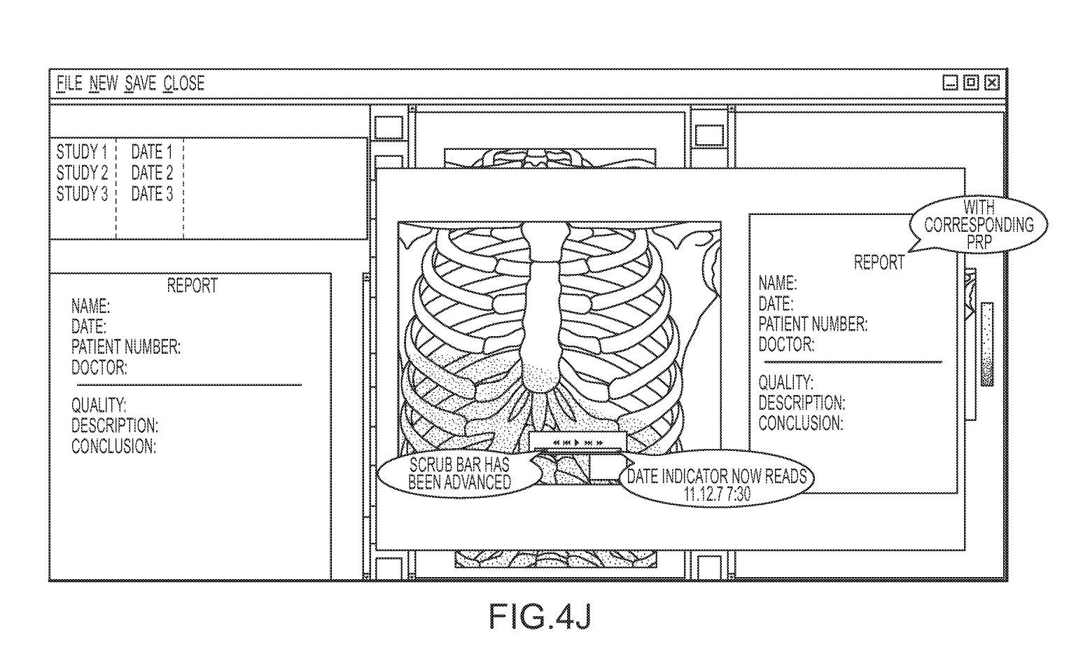

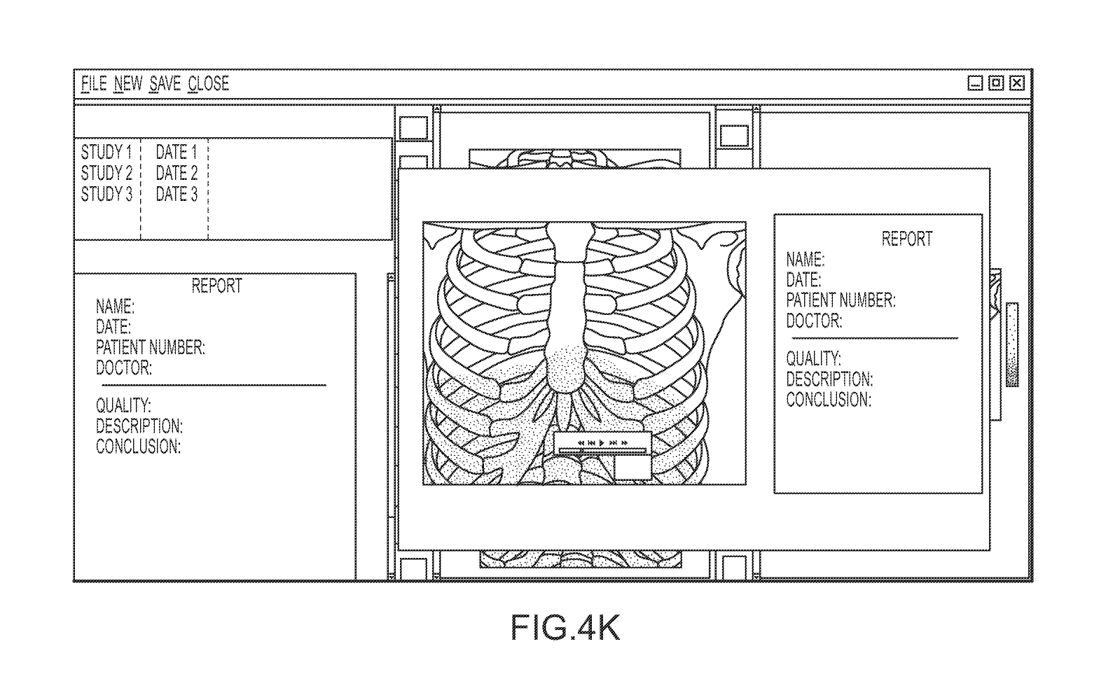

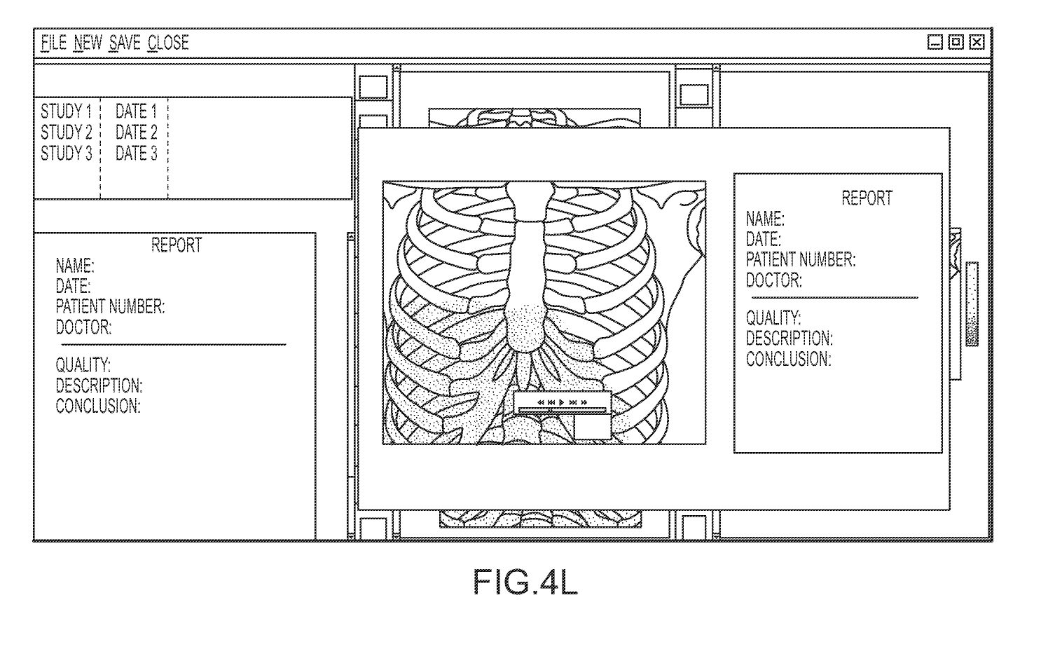

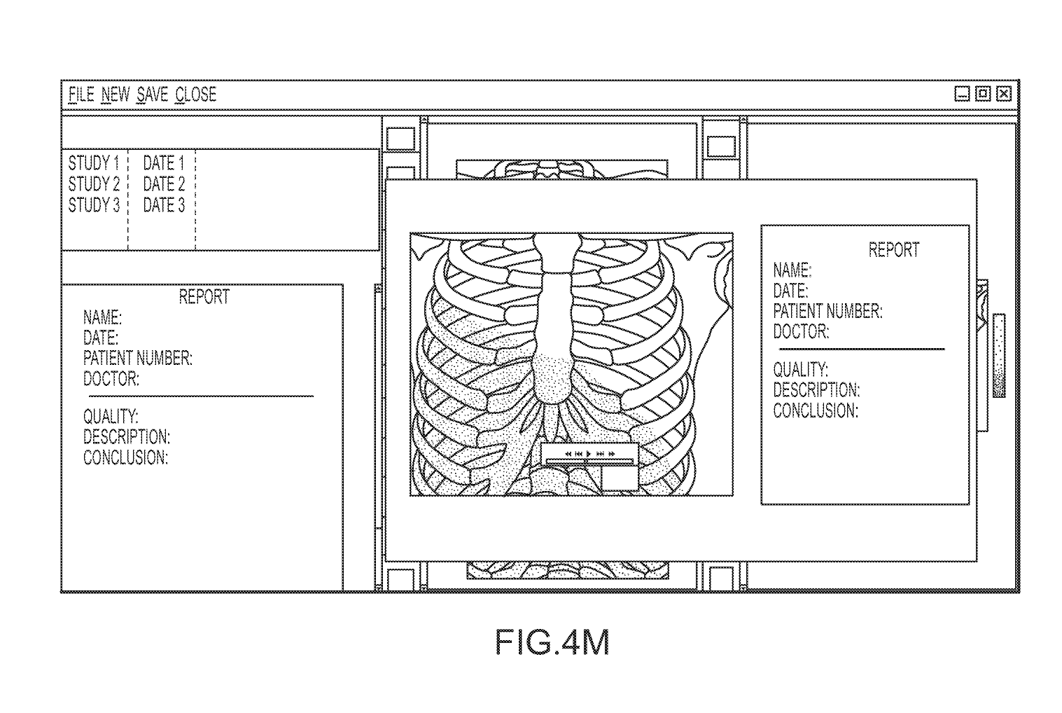

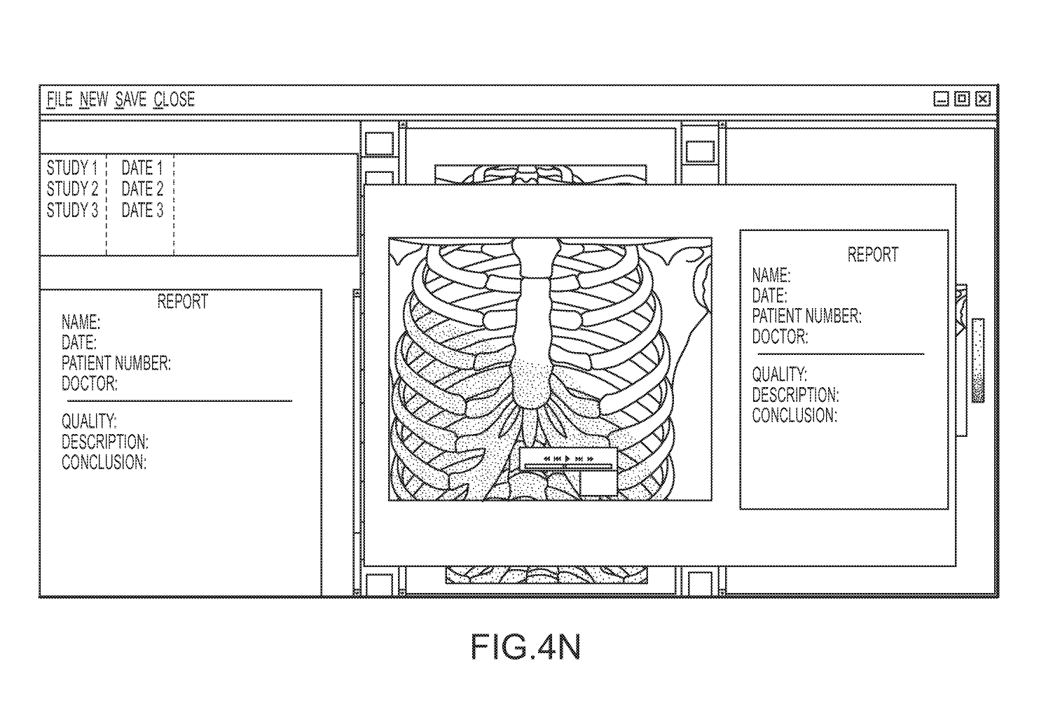

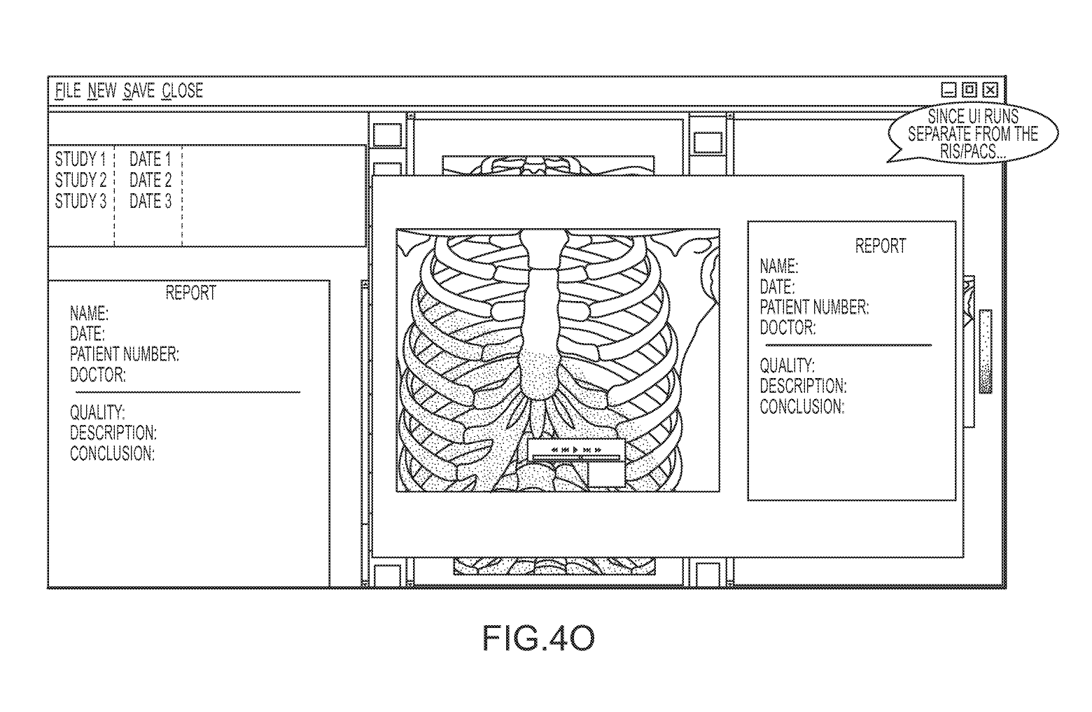

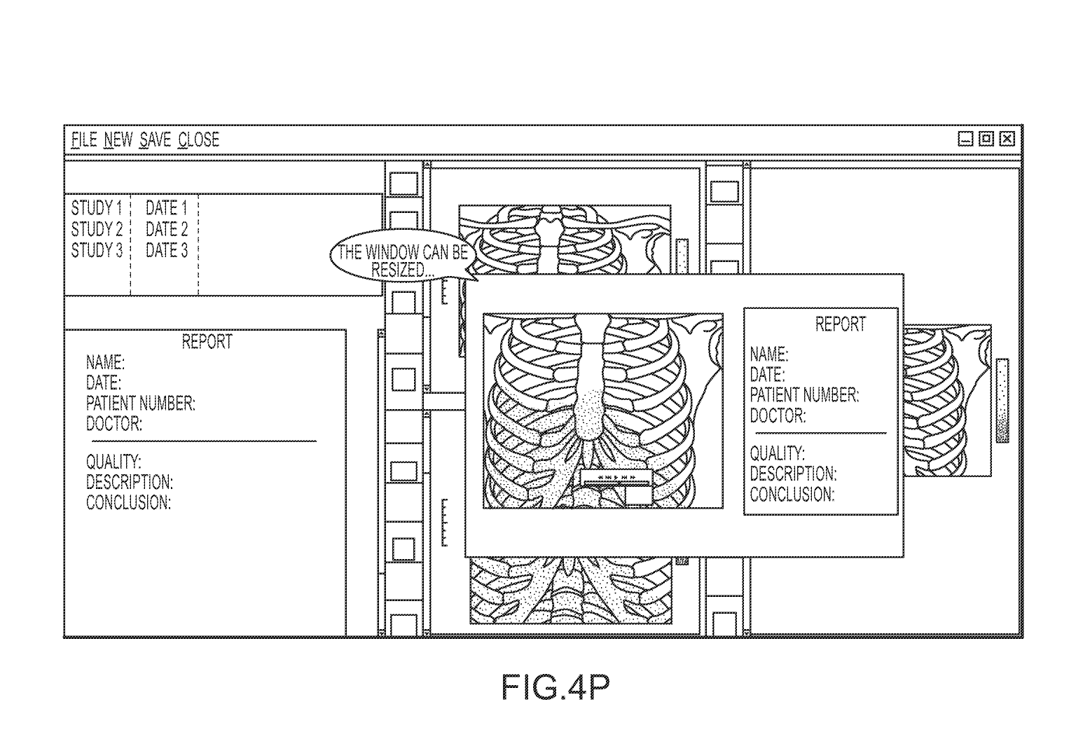

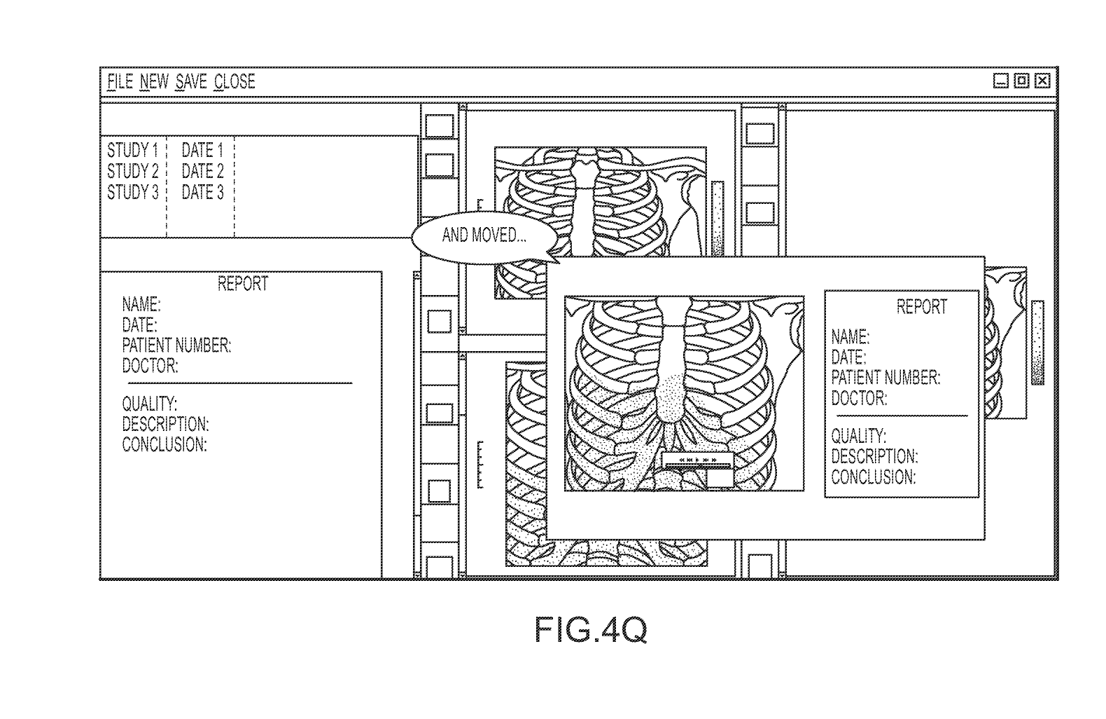

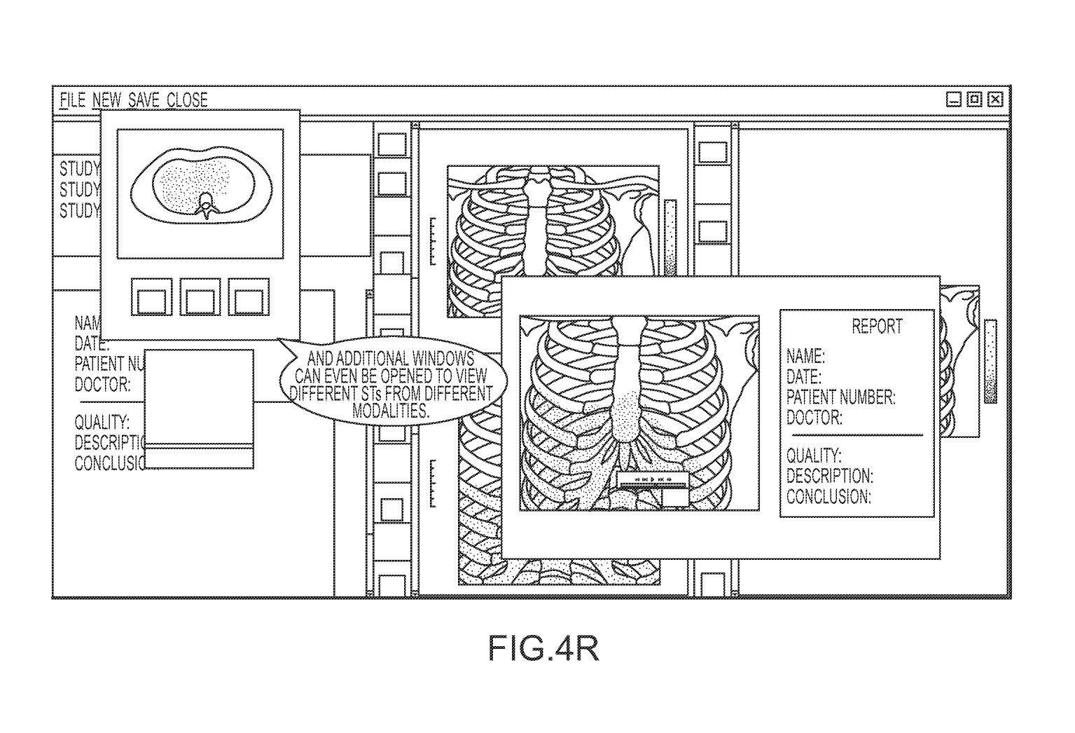

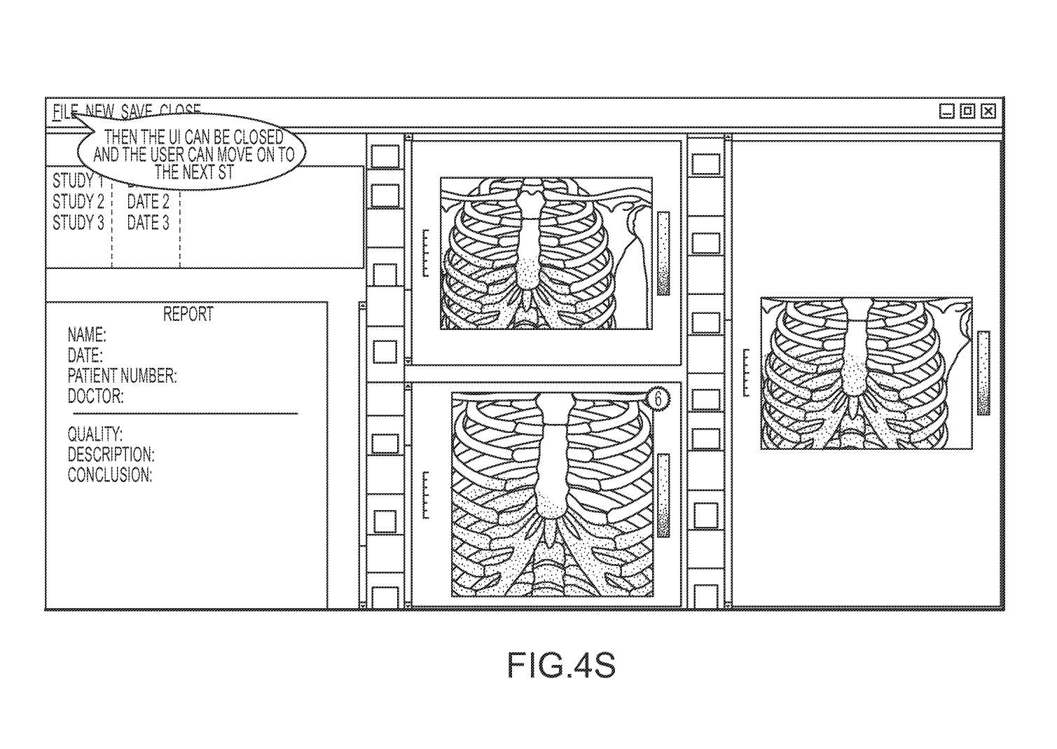

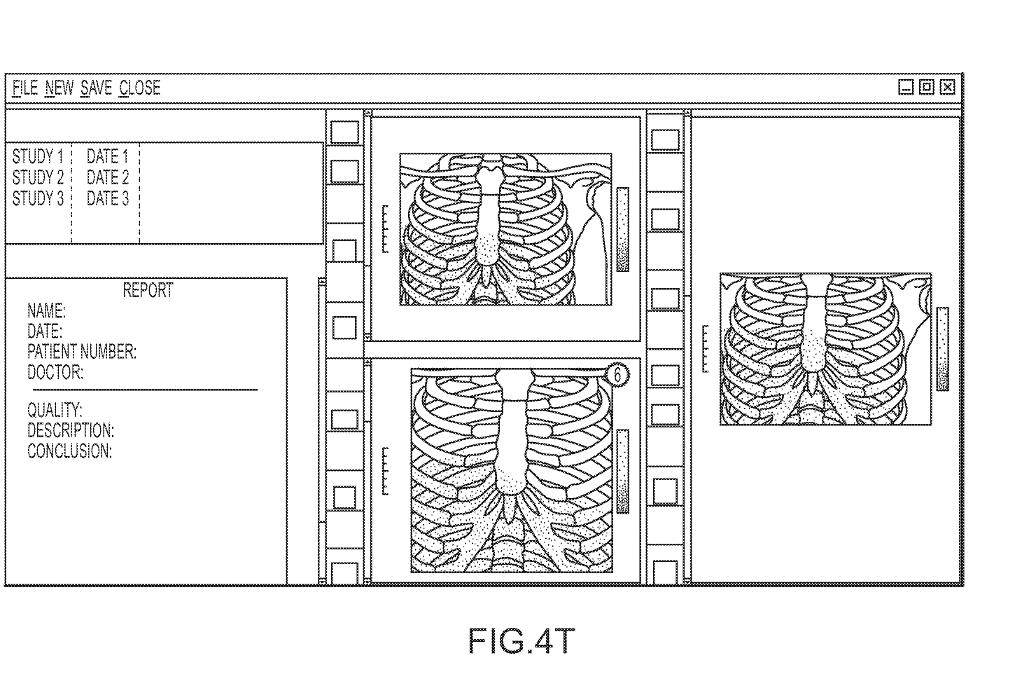

As shown in FIG. 4, in one embodiment of the presently disclosed user interface, the following methodology is employed. First, the CST is pulled up in the PACS. Second, a badge tells the interpreting radiologist how many PSTs of the same modality and type are available for comparison (e.g. if the CST is a x-ray of the chest, a badge with the number 5 means there are five PSTs that are x-rays of the chest available for comparison). Selection of the CST activates a contextual menu with access to the comparison user interface. The comparison user interface opens in a separate window that sits on top of the PACS. The CST is displayed along with PSTs and integrated PRPs in a customizable layout based on user preference. For example, the CST is displayed in the center of the window with thumbnails of the PSTs displayed in a column to the right alongside the corresponding PRPs.

The CST is determined to be the one being interpreted by default, but can be changed to any PST to change the frame of reference. The user then selects which PSTs and integrated PRPs will be used for comparison to the CST. The user can select a predetermined set of PSTs based on a single variable or a combination of variables selected from a variety of possible variables, non-limiting examples of which include: (1) a number of STs (i.e. compare to the last 5, 10, 15, etc. exams); (2) date of the PST (i.e. compare to the exams from the last week, month, year); and (3) event precipitating the PST (i.e. compare to the exams from this admission, prior admission, etc.). The user can also select a custom set of PSTs using a changeable, calendar-based interface (e.g. view by list, week, month, year).

Once the functional elements of the CST and the PSTs with integrated PRPs are defined, the new comparison user interface settings can be determined. The user can select a predetermined set of parameters based on a single variable or a combination of variables selected from a variety of possible variables, non-limiting examples of which include: (1) the CST and PSTs being merged using dissolve, flash, or other transition to cycle through each study in the sequence; (2) the transition between STs lasting 5, 10, 15, etc. seconds; and (3) the merged CST and PSTs are displayed to the left, right, top or bottom of the integrated PRPs.

The user can also set up a custom set of parameters. Once the functional elements of the comparison and the comparison user interface settings are defined, the comparison user interface opens an interactive window allowing the user to scroll back and forth from the most remote PST through the CST to sequentially interpret all of the images while having simultaneous access to the corresponding PRP at any given point in time.

Further, each PST will have an indicator on the timeline so the user can keep track of where they are in the sequence of events and transition quickly from one event to another, even skipping directly to any given date analogous to skipping directly to a desired scene in a rerecorded movie. Additionally, as noted above, the user can open multiple windows of the comparison user interface used to review all the radiological studies that a patient has had. For example, one window of the comparison user interface is used to review all of the current studies from a current admission may reveal that a patient has pulmonary edema. Also, a separate window can be used to quickly review the head CTs from the current admission, and a separate window can be used to quickly review the abdominal CTs from the current admission.

To illustrate this embodiment of the present disclosure, the following non-limiting example is provided. In using the presently disclosed novel user interface, the interpreting radiologist's notes that the CST, a chest XR, shows a diffuse interstitial infiltrate. A review of the most recent five chest x-rays shows that this infiltrate came on in the last two days, implying an acute process. The radiologist suspects pulmonary edema; however, the heart size is normal and has been for the past five STs.

Review of multiple head CTs in a separate UI window reveals that the patient has multiple hemorrhagic lesions with extra-axial blood, and a review of the multiple abdominal CTs in an additional UI window reveals that the patient has a renal cell cancer. Given the novel capabilities and advances of the present user interface, the radiologist is able to rapidly hypothesize that the patient has neurogenic pulmonary edema related to hemorrhagic metastases from a renal cell cancer. This efficiency and effectiveness of the impression is based upon review of multiple STs from multiple modalities that would have taken 30 minutes to an hour in the past but can be accomplished in minutes with this new comparison user interface.

In a further embodiment, the presently disclosed novel comparison user interface has limitless potential for applications. Any time change is being documented over time, the basic functional elements come into play. A series of events occurs over time. Some representation of each event is recorded (a photograph, image, graph, waveform). A document describing or detailing the event is recorded. This data can be combined for rapid review and interpretation.

The capabilities and advantages of this novel comparison user interface would be beneficial for any field of medicine where the physician is attempting to detect subtle changes in a patient over time. Non-limiting examples of other fields of use for this disclosed user interface include dermatology, ophthalmology, dentistry, cardiology and pulmonary-related diagnosis.

For example, a dermatologist could take sequential pictures of a suspicious lesion found on routine exam and review the pictures along with their interpretation each time the patient comes to help decide if the lesion warrants biopsy or excision or can simply be followed over time. An ophthalmologist can take pictures of a patient's retina each time he visits and follow the images over time to assess for subtle changes related to vasculopathy or other retinal pathology. A dentist can take sequential photographs of a patient undergoing teeth-whitening or straightening in order to monitor subtle changes over time and show the patient the results. A cardiologist can load multiple electrocardiograms (EKGs) into the comparison user interface to detect subtle changes in the waveforms that might predict ischemia while reviewing each prior dictated report at the same time to see how each was interpreted. A pulmonologist can similarly review multiple sequential pulmonary function test results to determine if a patient is responding to steroid therapy.

Finally, the presently disclosed novel comparison user interface would also be beneficial in non-medical applications where someone is trying to track any change over time along with any report or documentation of what techniques are being used to bring those changes about. For example, a person participating in a physical fitness regimen can take weekly pictures with a corresponding report of what exercises they are doing at that time to track changes in appearance and strength or endurance gains. A salon can take pictures of clients before and after each session along with a description of what was done during the visit (style of cut, clippers used, coloring used) so that a client can come back at a later date, review all of the images and select a cut from one visit and a color from another to achieve a desired look.

Most importantly though, the presently disclosed novel PACS user interface system provides numerous advantages over those which exist currently. First, the presently disclosed system allows a radiologist to access the PST and corresponding PRP at the same time. Current systems cannot link the PST from the PACS with the PRP from the RIS, but rather comprise separate PACS and RIS requiring the radiologist to log onto a different computer to pull up the RIS and view the PRP on a separate monitor, or even in integrated PACS and RIS systems, the PSTs and PRPs must still be pulled up independent of one another.

Second, the presently disclosed novel user interface system eliminates the arduous one-at-a-time comparison to the current study. In all existing systems, the PSTs must be pulled up individually for comparison to the CST, or at best, in systems that potentially allow for comparison to multiple PSTs at one time, all PSTs still must be pulled up and displayed in a single window. If four PSTs are pulled up for comparison, they all appear as tiles sized for display in a single window. Once the number of PSTs reaches a certain threshold, e.g. four to five, the tiles become too small to be useful. So, for example, in cases where twenty to thirty PSTs exist, it would be infeasible, if not utterly impossible, to pull up all twenty to thirty as tiles in a single window, as this resizing, even with four PSTs usually makes the images too small assess for subtle details and changes in relation to the CST.

Third, the presently disclosed novel user interface eliminates the side-by-side or side-to-side comparison. Further, this novel user interface disclosed here does not just allow for superimposed comparison to PSTs one at a time, but goes much further in allowing multiple PSTs to be viewed superimposed in chronological order leading up to the CST. Therefore, the presently disclosed system is superior to even a proposed superimposed system that requires toggling between a single PST and CST in a one-at-a-time fashion.

Additionally, the presently disclosed novel user interface also provides for predetermined or custom parameters to be programmed for viewing the CST and PSTs. Also, the presently disclosed user interface system allows for multiple windows of the comparison user interface to be open at one time in order to compare multiple STs from different modalities in order to get a complete overview and holistic picture of the patient's radiological data and history. This provides radiologists with the unique ability to view and diagnose disease or ailments based on information about an entire organ system or interaction of organ systems and not just a limited snapshot of one organ or body part.

Ultimately then, the presently disclosed novel user interface system provide several immediate advantages including (1) the ability to quickly review any number of PSTs and/or PRPs in relation to the CST without having to individually pull each PST or PRP or both; (2) the ability to pull up any number of PSTs and PRPs from any modality to get a more comprehensive view of the patient's medical condition; and (3) improved efficiency and consequently reduction in costs, namely healthcare costs to insurance companies government agencies and the consumers.

Even more importantly, improved accuracy of interpretation due to comparison to multiple PSTs significantly reduces the potential for medical errors in numerous ways. First, films that were mislabeled (from the wrong patient or loaded incorrectly, i.e. the image is reversed) instantly jump out as different from the rest in the series. Second, the presently disclosed system highlights changes in technique and positioning to help explain findings rather than relegating them to pitfalls in interpretation. For example, a patient appearing to have a new infiltrate on the CST comparison to the past five PSTs may reveal that this is only due to decreased lung volumes with crowding of the bronchopulmonary markings rather than a possible pneumonia that might require treatment with antibiotics.

Third, DICOM images that display the mA and KVP of an image can quickly be reviewed to see how changes in technique in image acquisition may explain changes in findings on the film. Finally, the subtle changes that take place over months or years become much more obvious because all of the PSTs can be compared at once as rapidly as the interpreting radiologist wants. For example, reviewing twelve chest x-rays spanning five years in seconds can show a subtle nodule increasing in size that might be imperceptible if only the most recent PSTs from the past year were reviewed side by side, one at a time.

Various embodiments of the invention are described above in the Detailed Description. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventor that the words and phrases in the specification and claims be given the ordinary and accustomed meanings to those of ordinary skill in the applicable art(s).

The foregoing description of a preferred embodiment, and best mode of the invention known to the applicant at this time of filing the application, have been presented and is intended for the purposes of illustration and description. It is not intended to be exhaustive nor limit the invention to the precise form disclosed and many modifications and variations are possible in the light of the above teachings. The embodiment was chosen and described in order to best explain the principles of the invention and its practical application and to enable others skilled in the art to best utilize the invention in various embodiments and with various modifications as are suited to the particular use contemplated. Therefore, it is intended that the invention not be limited to the particular embodiments disclosed for carrying out the invention.

What is claimed is:

1. A method for interpreting a radiological study, comprising:
accessing a current study for a first patient from a plurality of current studies from a plurality of patients in response to a request from a user;
determining a number of past studies for the first patient available for viewing and displaying that number to the user;
activating a contextual menu in response to the user's selection of the current study for the first patient, wherein the contextual menu allows access to a comparison user interface;
displaying the comparison user interface to the user;
accessing one or more past studies selected by the user from the plurality of past studies for the first patient based, wherein the selection of past studies is determined by one or more variables;
accessing one or more past reports for the first patient, wherein each past report access is based on a selected past study and is correlated with the selected past study; and
merging the current study with one or more selected past studies; wherein the merged output allows the user to transition from a first selected past study and its correlated past report to the current study.

2. The method of claim 1, wherein the current study is accessed via a PACS.

3. The method of claim 1, further including displaying one or more details of the past studies in response to a request from the user.

4. The method of claim 3, wherein the details of the past studies are selected from a group consisting of: modality, location, date, and event.

5. The method of claim 1, wherein the display of the past study correlated with the past report is customizable by the user.

6. The method of claim 1, wherein the variables for selection of past studies are predetermined.

7. The method of claim 1, wherein the variable for selection of the past studies are customizable by the user.

8. The method of claim 1, wherein the variable for selection of the past studies are selected from a group consisting of: number of studies, date, event and location.

9. The method of claim 1, wherein the current study is merged with one or more selected past studies in a manner selected by the user.

10. The method of claim 9, wherein the manner the current study is merged with one or more selected past studies is selected from a group consisting of: dissolve, flash, blur.

11. The method of claim 1, wherein the user selects the transition time between one or more selected past studies and the current study.

12. The method of claim 1, further including transitioning between one of the past studies and the current study as dictated by the user's operation of a scroll function, video scrub bar or progress bar.

13. A computer-readable storage medium containing computer executable code for instructing a computer to perform the steps of:
accessing a current study for a first patient from a plurality of current studies from a plurality of patients in response to a request from a user;
determining a number of past studies for the first patient available for viewing and displaying that number to the user;
activating a contextual menu in response to the user's selection of the current study for the first patient, wherein the contextual menu allows access to a comparison user interface;
displaying the comparison user interface to the user;
accessing one or more past studies selected by the user from the plurality of past studies for the first patient based, wherein the selection of past studies is determined by one or more variables;
accessing one or more past reports for the first patient, wherein each past report access is based on a selected past study and is correlated with the selected past study; and
merging the current study with one or more selected past studies, wherein the merged output allows the user to transition from a first selected past study and its correlated past report to the current study.

14. A user interface system for interpreting a radiological study, comprising:
a computer, in communication with a PACS, the computer including computer executable code for instructing a computer to perform the steps of:
accessing a current study for a first patient from a plurality of current studies from a plurality of patients in response to a request from a user;
determining a number of past studies for the first patient available for viewing and displaying that number to the user;
activating a contextual menu in response to the user's selection of the current study for the first patient, wherein the contextual menu allows access to a comparison user interface;
displaying the comparison user interface to the user;
accessing one or more past studies selected by the user from the plurality of past studies for the first patient based, wherein the selection of past studies is determined by one or more variables;
accessing one or more past reports for the first patient, wherein each past report access is based on a selected past study and is correlated with the selected past study; and
merging the current study with one or more selected past studies, wherein the merged output allows the user to transition from a first selected past study and its correlated past report to the current study.
